(19) United States
(12) Patent Application Publication
(10) Pub. No.: US 2018/0004984 A1
(43) Pub. Date: Jan. 4, 2018

(54) WEARABLE APPARATUSES COMPATIBLE WITH MULTIPLE SMARTCARDS

(71) Applicant: BOE TECHNOLOGY GROUP CO., LTD., Beijing (CN)

(72) Inventors: Bin Zou, Beijing (CN); Miao Liu, Beijing (CN); Hongna Ye, Beijing (CN); Xiaodong Shi, Beijing (CN); Guilong Yang, Beijing (CN); Feng Bai, Beijing (CN); Haoyu Zhao, Beijing (CN)

(73) Assignee: BOE TECHNOLOGY GROUP CO., LTD., Beijing (CN)

(21) Appl. No.: 15/542,066

(22) PCT Filed: Dec. 2, 2016
(86) PCT No.: PCT/CN2016/108358

§ 371 Date: Jul. 6, 2017

(30) Foreign Application Priority Data
Dec. 15, 2015 (CN) 201510939003.6

(51) Int. Cl. G06K 7/00; G06F 1/16; G06K 19/077

(52) U.S. Cl. CPC G06K 7/0052; G06K 7/0078; G06K 7/0021; G06F 1/163; G06K 7/006; G06K 19/0772; G06K 19/07743

(57) ABSTRACT

The present application discloses a wearable apparatus having an apparatus main body including at least one receptacle for detachably attaching a smartcard. The wearable apparatus is compatible with a plurality of smartcards.

### CROSS-REFERENCE TO RELATED APPLICATION

This application claims priority to Chinese Patent Application No. 201510939003.6, filed Dec. 15, 2015, the contents of which are incorporated by reference in the entirety.

### TECHNICAL FIELD

The present invention relates to wearable apparatuses, more particularly, to wearable apparatuses compatible with multiple smartcards and a kit having the same.

### BACKGROUND

Various types of wearable apparatuses have been developed in recent years. Examples of wearable apparatuses include portable apparatuses such as watches, glasses, and wristbands; and attachable apparatuses such as a patch. Wearable apparatuses have found a wide range of applications, including, e.g., fitness tracking devices, wearable medical devices, and payment transaction systems.

### SUMMARY

In one aspect, the present invention provides a wearable apparatus comprising an apparatus main body comprising at least one receptacle for detachably attaching a smartcard; wherein the wearable apparatus is compatible with a plurality of smartcards.

Optionally, the wearable apparatus is compatible with a plurality of smartcards having different pin configurations.

Optionally, the wearable apparatus is compatible with a plurality of smartcards having a same pin configuration but different dimensions.

Optionally, the apparatus main body further comprises a casing; and a motherboard enclosed by the casing; the at least one receptacle being disposed on the motherboard.

Optionally, the motherboard comprises a copper pour area comprising a plurality of electrical routing traces and a non-copper pour area outside the copper pour area; the at least one receptacle are disposed on the motherboard in the non-copper pour area.

Optionally, the motherboard comprises a first region and a second region; substantially all electronic components and metal pad structures of the motherboard are disposed in the first region; the second region is substantially free of electronic components and metal pad structures; and the at least one receptacle are disposed on the motherboard in the second region.

Optionally, the wearable apparatus further comprises a display panel attached to the casing and electrically connected to the motherboard; wherein projections of the at least one receptacle on the motherboard are outside that of the display panel.

Optionally, the casing comprises an aperture through which the smartcard is configured to be attached to or detached from the at least one receptacle; and the wearable apparatus further comprises a seal surrounding the aperture, the seal configured to form a waterproof closure of the aperture when the aperture is closed.

Optionally, the seal is a rubber seal.

Optionally, the casing comprises an aperture through which the smartcard is configured to be attached to or detached from the at least one receptacle; and the wearable apparatus further comprises an aperture cover movably connected to the casing; and configured to be movable between a first position at which the aperture is accessible and a second position at which the aperture is substantially closed.

Optionally, the casing comprises an aperture through which the smartcard is configured to be attached to or detached from the at least one receptacle; and the wearable apparatus further comprises an ejector configured to eject the smartcard.

Optionally, the apparatus main body further comprises a casing, a motherboard enclosed by the casing, the at least one receptacle being disposed on the motherboard; and an opener configured to open the casing to allow the smartcard to be attached to or detached from the at least one receptacle.

Optionally, the opener comprises one of an opening hole, a button, and a knob.

Optionally, the apparatus main body comprises at least two receptacles each of which having a different pin configuration.

Optionally, the wearable apparatus further comprises a smartcard detachably attached to the at least one receptacle; wherein the smartcard comprises a security element integrated in the smartcard.

Optionally, the smartcard is one of a transit card chip, a dual interface card, a near field communication chip, a secure digital memory card, and a subscriber identity module card.

Optionally, the wearable apparatus further comprises a support attached to the at least one receptacle and configured to detachably attaching the smartcard in the at least one receptacle; wherein the support comprises a slot configured to receive the smartcard and have the smartcard latched therein.

Optionally, the at least one receptacle is detachably attached to the apparatus main body.

Optionally, the apparatus main body further comprises a casing and a motherboard enclosed by the casing; the motherboard comprises a coupler for detachably attaching the at least one receptacle.

Optionally, the coupler comprises a guide rail for detachably attaching the at least one receptacle.

Optionally, the coupler comprises a bolt and a bolt hole cooperatively configured to secure the at least one receptacle to the coupler.

In another aspect, the present invention provides a kit comprising a plurality of receptacles, each of which configured to be detachably attached to the apparatus main body; wherein the plurality of receptacles comprise a first receptacle compatible with a first smartcard having a first pin configuration and a second receptacle compatible with a second smartcard having a second pin configuration, the first pin configuration being different from the second pin configuration.

Optionally, the kit further comprises a wearable apparatus described herein.

In another aspect, the present invention provides a kit comprising a plurality of supports, each of which being configured to be detachably attached to the at least one receptacle, each of which being configured to detachably attaching a smartcard in the at least one receptacle; wherein the plurality of supports comprise a first support comprising a first slot having a first slot dimension and a second support comprising a second slot having a second slot dimension, the first slot dimension being different from the second slot dimension.

Optionally, the first support is configured to secure a first smartcard having a first smartcard dimension matching with the first slot dimension to the at least one receptacle; and the second support is configured to secure a second smartcard having a second smartcard dimension matching with the second slot dimension to the at least one receptacle; the first smartcard dimension and the second smartcard dimension being different.

Optionally, the first smartcard and the second smart card have a same pin configuration.

Optionally, the kit further comprises a wearable apparatus described herein.

### BRIEF DESCRIPTION OF THE FIGURES

The following drawings are merely examples for illustrative purposes according to various disclosed embodiments and are not intended to limit the scope of the present invention.

FIG. 1 is a diagram illustrating the structure of a wearable apparatus in some embodiments according to the present disclosure.

FIG. 2 is a diagram illustrating the structure of an apparatus main body in some embodiments according to the present disclosure.

FIG. 3 is a diagram illustrating the structure of a motherboard in some embodiments according to the present disclosure.

FIG. 4 is a diagram illustrating the structure of a motherboard in some embodiments according to the present disclosure.

FIG. 5 is a diagram illustrating the structure of a wearable apparatus in some embodiments according to the present disclosure.

FIG. 6 is a diagram illustrating the structure of a wearable apparatus in some embodiments according to the present disclosure.

FIG. 7 is a diagram illustrating the structure of a wearable apparatus in some embodiments according to the present disclosure.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

In some conventional wearable apparatuses, a smartcard, e.g., a transit card or a near field communication chip, is included. A user wearing the wearable apparatus may use it to complete a transaction such as a credit card transaction or payments for commute. However, the conventional wearable payment apparatuses include only a single payment smartcard affixed in the wearable payment apparatuses. Therefore, one wearable payment apparatus can only be used for one type of payment transaction.

Accordingly, the present invention provides, inter alia, a wearable apparatus compatible with multiple smartcards and a kit having the same that substantially obviates one or more of the problems due to limitations and disadvantages of the related art. In some embodiments, the wearable apparatus includes an apparatus main body having at least one receptacle configured to detachably attaching a smartcard. Optionally, the wearable apparatus further includes a smartcard detachably attached to the at least one receptacle. Optionally, the wearable apparatus is compatible with a plurality of smartcards. As used herein, the term the term “detachably connected” refers to configurations in which an element is attached to another element while the element is detachable from the other element without damage. Optionally, the elements are joined together by means configured to allow for the separation of the components at the point of attachment. In some embodiments, the wearable apparatus is compatible with a plurality of smartcards having different pin configuration. Optionally, the wearable apparatus includes a plurality of receptacles having different pin configurations corresponding to a plurality of smartcard having different pin configurations. Optionally, the wearable apparatus includes at least one receptacle that is compatible with a plurality of smartcard having different pin configurations. Optionally, the wearable apparatus is a wearable payment apparatus including a payment smartcard. Optionally, the plurality of smartcard having different pin configurations are a plurality of payment smartcards.

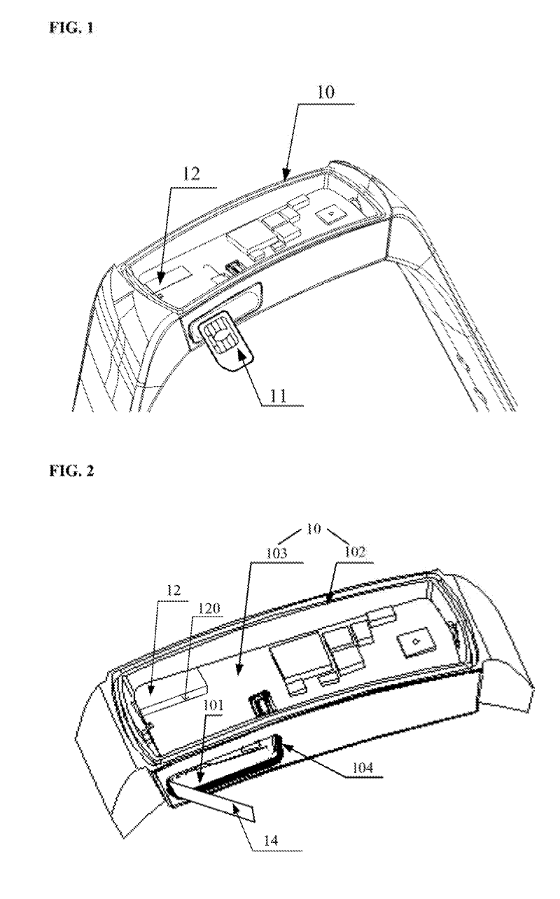

FIG. 1 is a diagram illustrating the structure of a wearable apparatus in some embodiments according to the present disclosure. Referring to FIG. 1, the wearable apparatus in some embodiments includes an apparatus main body 10 and a smartcard 11. The apparatus main body 10 includes a receptacle 12 for receiving the smartcard 11, which is detachably attached to the receptacle 12. By having this design, various types of smartcards may be compatibly used with the present wearable apparatus. Examples of smartcards include, but are not limited to, transit card chip, a dual interface card, a near field communication chip, a secure digital memory card, and a subscriber identity module card. For example, a single wearable apparatus is capable of supporting various payment transaction systems. Moreover, the present wearable apparatus can be compatibly used with smartcards having various pin configurations, obviating the need for a separate apparatus for each smartcard having a different pin configuration.

FIG. 2 is a diagram illustrating the structure of an apparatus main body in some embodiments according to the present disclosure. Referring to FIG. 2, the apparatus main body 10 further includes a casing 102 and a motherboard 103 enclosed by the casing 102. As shown in FIG. 2, the receptacle 12 is disposed on the motherboard 103, the casing 102 has an aperture 101 through which a smartcard may be attached to or detached from the receptacle 12. In FIG. 2, the receptacle 12 includes a pluggable interface 120 compatible with a pluggable interface in the smartcard. The pluggable interface 120 is disposed in a position facing the aperture 101.

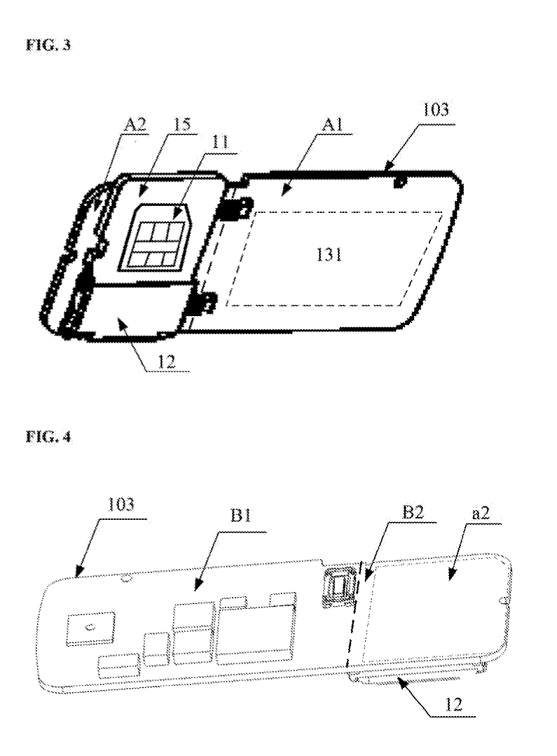

FIG. 3 is a diagram illustrating the structure of a motherboard in some embodiments according to the present disclosure. Referring to FIG. 3, the motherboard 103 in some embodiments includes a copper pour area A1 and a non-copper pour area A2. The copper pour area A1 includes a plurality of electrical routing metal traces, which may be formed by etching the copper pour or by forming pad window structures. The non-copper pour area A2 is outside the copper pour area A1, and is substantially free of electrical routing metal traces. The receptacle 12 and the smartcard 11 are disposed on the motherboard 103 in the non-copper pour area A2, as shown in FIG. 3. Projections of the receptacle 12 and the smartcard 11 on the motherboard 103 are outside that of the copper pour area A1. By disposing the receptacle 12 and the smartcard 11 in an area substantially free of electrical routing metal traces, the present wearable apparatus obviates shielding of smartcard signals by the metal traces.

The motherboard 103 may have one of a single layer structure or a laminated multi-layer structure. Examples of motherboards include, but are not limited to, a printed circuit board and a flexible printed circuit board.

FIG. 4 is a diagram illustrating the structure of a motherboard in some embodiments according to the present disclosure. Referring to FIG. 4, the motherboard 103 in some embodiments includes a first region B1 and a second region B2. Substantially all electronic components and metal pad structures of the motherboard 103 are disposed in the first region B1, and the second region B2 is substantially free of electronic components and metal pad structures. The receptacle 12 and the smartcard 11 are disposed on the motherboard 103 in the second region B2, as shown in FIG. 4. Projections of the receptacle 12 and the smartcard 11 are outside that of the first region B1. Referring to FIGS. 3 and 4, a projection of the non-copper pour area A2 on the motherboard 103 is substantially within, or coextensive with, that of the second region B2. The copper pour area A1 and the electronic components and metal pad structures of the motherboard 103 may be disposed on a same surface of the motherboard 103. Optionally, the copper pour area A1 is on a surface of the motherboard 103 opposite to the surface on which the electronic components and metal pad structures of the motherboard 103 are disposed. By disposing the receptacle 12 and the smartcard 11 in an area substantially free of electronic components and metal pad structures, the present wearable apparatus obviates shielding of smartcard signals by the electronic components and metal pad structures.

FIG. 5 is a diagram illustrating the structure of a wearable apparatus in some embodiments according to the present disclosure. Referring to FIG. 5, the wearable apparatus in some embodiments further includes a display panel 13 electrically connected to the motherboard 103 and attached to the casing. Projections of the receptacle 12 and the smartcard on the motherboard 103 are outside a projection 131 of the display panel 13 on the motherboard 103. Optionally, the projection 131 of the display panel 13 on the motherboard 103 is outside that of the non-copper pour area. Optionally, the projection 131 of the display panel 13 on the motherboard 103 is within that of the copper pour area or substantially coextensive with that of the copper pour area. By disposing the receptacle 12 and the smartcard 11 in an area outside that of the display panel, the present wearable apparatus obviates shielding of smartcard signals by the display panel.

Referring to FIG. 2, the wearable apparatus in some embodiments further includes an aperture cover 14 movably connected to the casing 102. The aperture cover 14 is configured to be movable between a first position at which the aperture 101 is accessible (e.g., the aperture cover 14 in an open state) and a second position at which the aperture 101 is substantially closed (e.g., the aperture cover 14 in a closed state). Optionally, the aperture cover 14 has a dimension and a shape matching with those of the aperture 101, which ensures effective enclosure of the smartcard in the apparatus main body when the aperture 101 is closed by the aperture cover 14. Optionally, the wearable apparatus further includes a seal surrounding an edge of the aperture cover 14 for protecting the aperture cover 14, e.g., buffering the opening and closing motion of to reduce impact on the aperture cover 14.

Referring to FIG. 2, the wearable apparatus in some embodiments further includes a seal 104 surrounding the aperture 101. For example, the seal 104 may be configured to form a waterproof closure of the aperture 101 when the aperture 101 is closed, e.g., by the aperture cover 14. Optionally, the seal 104 is a rubber seal.

In some embodiments, the wearable apparatus further includes an ejector configured to eject the smartcard 11. Optionally, the ejector is disposed on the receptacle 12.

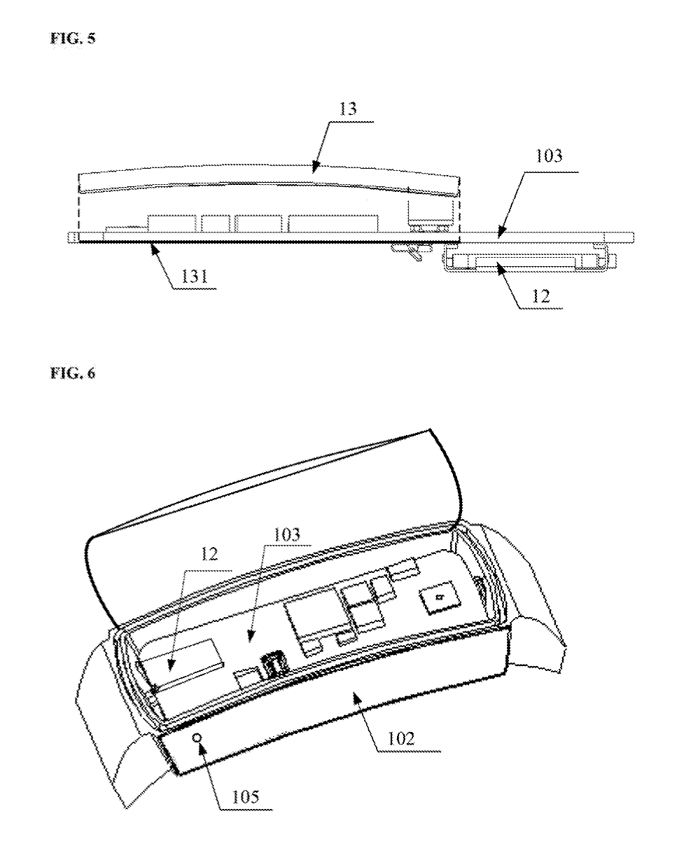

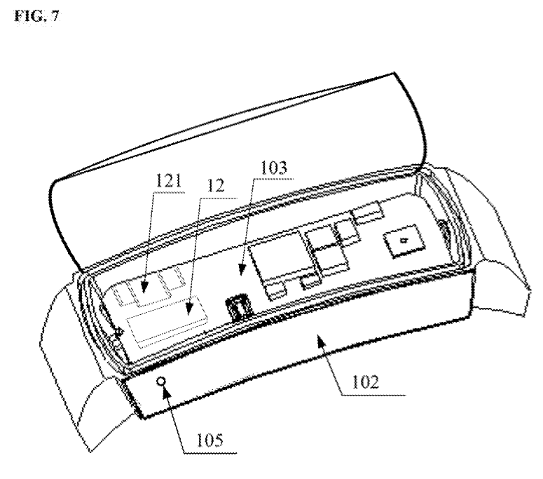

FIG. 6 is a diagram illustrating the structure of a wearable apparatus in some embodiments according to the present disclosure. Referring to FIG. 6, the apparatus main body further includes a casing 102, a motherboard 103 enclosed by the casing 102, and an opener 105 configured to open the casing 102 to allow the smartcard to be attached to or detached from the receptacle 12 disposed on the motherboard 103. Examples of opener include, but are not limited to, an opening hole, a button, and a knob.

As shown in FIG. 6, the opener 105 in some embodiments is an opening hole. The wearable apparatus further includes a latching device connected to the opening hole. The latching device may be opened by a pin or a plat extending through the opening hole, thereby opening the casing 102.

In some embodiments, the apparatus main body includes at least two receptacles, each of the at least two receptacles having a different pin configuration. Optionally, the apparatus main body includes a plurality of receptacles, each of which has a pin configuration different from those of the rest of the receptacles. In some embodiments, the apparatus main body includes a receptacle that is compatible with a plurality of smartcard having different pin configurations. For example, a receptacle may have a first pin having a first pin configuration and a second pin having a second pin configuration, the first pin and the second pin disposed at different locations (e.g., different sides) of the receptacle, the first pin configuration being different from the second pin configuration.

In some embodiments, the smartcard includes a security element integrated in the smartcard. Different payment transaction systems use different security elements. In conventional apparatuses, the security element is integrated in the apparatus main body. By having the security element integrated into the smartcard rather than integrated into the apparatus main body, a single wearable apparatus can be conveniently made to be compatible with various payment transaction systems. When a user wants to use the same wearable apparatus for a different payment transaction system, the user may simply switch the smartcard in the wearable apparatus.

Various smartcards may be used in combination with the present apparatus main body. Examples of smartcards include, but are not limited to, transit card chip, a dual interface card, a near field communication chip, a secure digital memory card, and a subscriber identity module card. In one aspect, the present disclosure provides a smartcard having a security element integrated into the smartcard.

Referring to FIG. 3, the wearable apparatus in some embodiments further includes a support 15 attached to the receptacle 12 and configured to secure the smartcard 11 in the receptacle 12. Optionally, the support 15 includes a slot configured to receive the smartcard 11 and configured to have the smartcard latched in the slot. Optionally, the support 15 has a dimension matching with that of the receptacle 12. Optionally, the slot in the support 15 has a dimension matching with that of the smartcard 1. Optionally, the support 15 is detachably attached to the receptacle 12.

In some embodiments, the wearable apparatus having a receptacle may be made to be compatible with a plurality of smartcards having a same pin configuration but different dimensions. For example, such a wearable apparatus includes at least one receptacle having a first dimension and a support having a second dimension matching with the first dimension, the support includes a slot having a third dimension matching with a fourth dimension of a smartcard. When a user wants to use the same wearable apparatus for a different smartcard having a same pin configuration but different dimension, the user may choose a support including a slot having a third dimension matching with a fourth dimension of a smartcard of choice.

In one aspect, the present disclosure provides a kit having a wearable apparatus, e.g., a kit for various payment transaction systems. In some embodiments, the kit includes an apparatus main body having at least one receptacle; and a plurality of supports configured to be detachably attached to the at least one receptacle and secure a smartcard in the at least one receptacle. Each of the plurality of supports has a slot having a dimension matching with a dimension of a smartcard. The kit includes at least a first support including a first slot having a first slot dimension and a second support including a second slot having a second slot dimension, the first slot dimension being different from the second slot dimension. Optionally, the first support is configured to secure a first smartcard having a first smartcard dimension matching with the first slot dimension, and the second support is configured to secure a second smartcard having a second smartcard dimension matching with the second slot dimension. Optionally, the first smartcard dimension and the second smartcard dimension are different, and the first smartcard and the second smart card have a same pin configuration.

In some embodiments, the support and the aperture cover are integrated into a single structure. For example, the integral structure may include a first portion and a second portion integrated together, the first portion is a support for securing a smartcard in the receptacle, and the second portion is an endcap serving as an aperture cover configured to close the aperture. Optionally, the endcap has a dimension matching that of the aperture. By having this design, the smartcard can be placed in the support. The support and the endcap of the integral structure cooperatively attach the smartcard in the receptacle and close the aperture in one step.

In some embodiments, the wearable apparatus can be compatibly used with various different types of smartcards, as discussed above. Optionally, the present wearable apparatus allows a user conveniently switch a smartcard in the wearable apparatus to a different smartcard, e.g., a different smartcard having a same pin configuration. In some embodiments, the wearable apparatus can be compatibly used with smartcards having different security elements. Optionally, a firmware program of the wearable apparatus supports a plurality of security elements corresponding to a plurality of smartcards. Optionally, an application in a server in communication with the wearable apparatus supports a plurality of security elements corresponding to a plurality of smartcards. In some embodiments, the wearable apparatus can be compatibly used with smartcards having different operating systems. Optionally, a firmware program of the wearable apparatus supports a plurality of operating systems corresponding to a plurality of smartcards. Optionally, an application in a server in communication with the wearable apparatus supports a plurality of operating systems corresponding to a plurality of smartcards.

In some embodiments, the wearable apparatus can be compatibly used with different smartcards having different pin configurations. Optionally, a single wearable apparatus is compatible with a plurality of smartcards having different pin configurations. Optionally, a single wearable apparatus includes a plurality of receptacles, each of which is compatible with a smartcard having a different pin configuration. In one aspect, the present disclosure provides a kit including a plurality of wearable apparatuses, each of which is compatible with a smartcard having a different pin configuration.

In some embodiments, the at least one receptacle is detachably attached to the apparatus main body. FIG. 7 is a diagram illustrating the structure of a wearable apparatus in some embodiments according to the present disclosure. Referring to FIG. 7, the motherboard 103 further includes a coupler 121 for detachably attaching the receptacle 12. By having this design, the present wearable apparatus allows a user conveniently switch a receptacle in the wearable apparatus to a different receptacle, e.g., a different receptacle compatible with a smartcard having a different pin configuration.

In one aspect, the present disclosure provides a kit having a wearable apparatus, e.g., a kit for various payment transaction systems. In some embodiments, the kit includes an apparatus main body having a coupler for detachably attaching a plurality of receptacles; and a plurality of receptacles. Each of the plurality of receptacles is configured to be detachably attached to the apparatus main body, e.g., through the coupler. The kit includes at least a first receptacle compatible with a first smartcard having a first pin configuration and a second receptacle compatible with a second smartcard having a second pin configuration, the first pin configuration being different from the second pin configuration. Optionally, the plurality of receptacles may be detachably attached to the apparatus main body using a universal coupler. Optionally, the kit includes an apparatus main body; a plurality of receptacles; and a coupler for detachably attaching the plurality of receptacles.

Referring to FIG. 7, the coupler 121 in some embodiments includes at least one guide rail for detachably attaching the receptacle 12. Optionally, the coupler 121 includes a first guide rail and a second guide rail, the first guide rail is compatible with a first receptacle having a first dimension, and the second guide rail is compatible with a second receptacle having a second dimension.

In some embodiments, the coupler includes a bolt and a bolt hole cooperatively configured to secure the receptacle to the coupler. Optionally, the coupler includes a plurality of pairs of bolts and bolt holes, each pair cooperatively configured to secure the receptacle to the coupler.

In some embodiments, the casing of the wearable apparatus may be opened by the opener on the casing. Once the casing is opened, the receptacle may be conveniently attached to or detached from the apparatus main body through the coupler.

In some embodiments, the wearable apparatus further includes an antenna for receiving and transmitting smartcard signals. Optionally, the antenna is disposed in the smartcard. Optionally, the antenna is disposed in the apparatus main body, e.g., in the motherboard or the casing.

Examples of wearable apparatuses include, but are not limited to, a smart watch, an electronic ring, an electronic necklace, an electronic bracelet, an electronic badge, an electronic fitness monitoring device, a smart wristband, an electronic hat, smart glasses, a wearable apparatus that is worn on clothing, a wearable apparatus that when worn contacts human skin. In some embodiments, the wearable apparatus further includes a processor, a memory, a user interface including a display and an input device. Optionally, the wearable apparatus further includes one or more sensor. Optionally, the wearable apparatus further includes a security authentication system, e.g., a fingerprint recognition system or a voice recognition system. Optionally, the wearable apparatus further includes a power supply.

In another aspect, the present disclosure provides a kit comprising an apparatus main body as described herein, e.g., a payment transaction system kit. For example, the apparatus main body may include a motherboard and a casing. Optionally, the apparatus main body further includes one or more of a processor, a memory, a user interface including a display and an input device, one or more sensor, a security authentication system, e.g., a fingerprint recognition system or a voice recognition system, and a power supply.

In some embodiments, the kit further includes a plurality of receptacles for detachably attaching a plurality of smartcards, respectively, to the apparatus main body. Optionally, each of the plurality of smartcards is configured to be detachably attached to the apparatus main body, e.g., through the receptacle detachably attached to a coupler. Optionally, the kit includes at least a first receptacle compatible with a first smartcard having a first pin configuration and a second receptacle compatible with a second smartcard having a second pin configuration. Optionally, the first pin configuration is different from the second pin configuration. Optionally, the first pin configuration is the same as the second pin configuration. Optionally, the kit further includes one or more coupler. Optionally, the coupler is affixed to the apparatus main body. Optionally, the coupler is detachably attached to the apparatus main body. Optionally, the coupler is a universal coupler for detachably attaching the plurality of receptacles to the apparatus main body. Optionally, the kit includes a plurality of couplers configured to detachably attaching a plurality of receptacles to the apparatus main body, respectively. Optionally, each of the plurality of receptacles is configured to be detachably attached to the apparatus main body, e.g., through one of the plurality of couplers.

In some embodiments, the kit further includes a plurality of supports for detachably attaching a plurality of smartcards, respectively, to a receptacle. Optionally, each of the plurality of supports is configured to be detachably attached to a receptacle, and configured to detachably attaching a smartcard to the receptacle. Optionally, each of the plurality of supports has a slot having a dimension matching with a dimension of a smartcard. Optionally, the kit includes at least a first support including a first slot having a first slot dimension and a second support including a second slot having a second slot dimension. Optionally, the first slot dimension is different from the second slot dimension. Optionally, the first slot dimension is the same as the second slot dimension. Optionally, the first support is configured to secure a first smartcard having a first smartcard dimension matching with the first slot dimension, and the second support is configured to secure a second smartcard having a second smartcard dimension matching with the second slot dimension. Optionally, the first smartcard dimension and the second smartcard dimension are different, and the first smartcard and the second smart card have a same pin configuration. Optionally, the first smartcard dimension and the second smartcard dimension are different, and the first smartcard and the second smart card have different pin configurations. Optionally, the kit includes a plurality of receptacles configured for detachably attaching the plurality of supports, respectively. Optionally, the kit includes a universal receptacle configured for detachably attaching the plurality of supports.

In some embodiments, the kit further includes a plurality of receptacles for detachably attaching a plurality of smartcards, respectively, to the apparatus main body; and a plurality of supports for detachably attaching a plurality of smartcards, respectively, to a receptacle. Optionally, each of the plurality of smartcards is configured to be detachably attached to the apparatus main body, e.g., through the receptacle detachably attached to a coupler. Optionally, each of the plurality of supports is configured to be detachably attached to a receptacle, and configured to detachably attaching a smartcard to the receptacle. Optionally, each of the plurality of supports has a slot having a dimension matching with a dimension of a smartcard. Optionally, the kit further includes one or more coupler. Optionally, the coupler is affixed to the apparatus main body. Optionally, the coupler is detachably attached to the apparatus main body. Optionally, the coupler is a universal coupler for detachably attaching the plurality of receptacles to the apparatus main body. Optionally, the kit includes a plurality of couplers configured to detachably attaching a plurality of receptacles to the apparatus main body, respectively. Optionally, each of the plurality of receptacles is configured to be detachably attached to the apparatus main body, e.g., through one of the plurality of couplers. Optionally, the kit includes a plurality of receptacles configured for detachably attaching the plurality of supports, respectively. Optionally, the kit includes a universal receptacle configured for detachably attaching the plurality of supports. Optionally, the kit includes at least a first receptacle compatible with a first smartcard having a first pin configuration and a second receptacle compatible with a second smartcard having a second pin configuration. Optionally, the first pin configuration is different from the second pin configuration. Optionally, the first pin configuration is the same as the second pin configuration. Optionally, the kit includes at least a first support including a first slot having a first slot dimension and a second support including a second slot having a second slot dimension. Optionally, the first slot dimension is different from the second slot dimension. Optionally, the first slot dimension is the same as the second slot dimension. Optionally, the first support is configured to secure a first smartcard having a first smartcard dimension matching with the first slot dimension, and the second support is configured to secure a second smartcard having a second smartcard dimension matching with the second slot dimension. Optionally, the first smartcard dimension and the second smartcard dimension are different, and the first smartcard and the second smart card have a same pin configuration. Optionally, the first smartcard dimension and the second smartcard dimension are different, and the first smartcard and the second smart card have different pin configurations.

Optionally, the kit further includes instructions on how to assemble the wearable apparatus. Optionally, the kit further includes an opener for opening the casing to allow the smartcard to be attached to or detached from the apparatus main body. Optionally, the kit further includes a firmware or a software. Optionally, the kit further includes one or more smartcards. Optionally, the one or more smartcards are smartcards having security elements therein.

In another aspect, the present disclosure provides an accessory kit for attaching a smartcard to a wearable apparatus. For example, the accessory kit is an accessory kit for use in combination with a wearable apparatus, e.g., a payment transaction system wearable apparatus.

In some embodiments, the accessory kit includes a plurality of receptacles for detachably attaching a plurality of smartcards, respectively, to an apparatus main body of the wearable apparatus. Optionally, the accessory kit includes at least a first receptacle compatible with a first smartcard having a first pin configuration and a second receptacle compatible with a second smartcard having a second pin configuration. Optionally, the first pin configuration is different from the second pin configuration. Optionally, the first pin configuration is the same as the second pin configuration. Optionally, the accessory kit further includes one or more coupler configured to be detachably attached to the apparatus main body. Optionally, the coupler is a universal coupler for detachably attaching the plurality of receptacles to the apparatus main body. Optionally, the accessory kit includes a plurality of couplers configured to detachably attaching a plurality of receptacles to the apparatus main body, respectively. Optionally, each of the plurality of receptacles is configured to be detachably attached to the apparatus main body, e.g., through one of the plurality of couplers.

In some embodiments, the accessory kit further includes a plurality of supports for detachably attaching a plurality of smartcards, respectively, to a receptacle. Optionally, each of the plurality of supports is configured to be detachably attached to a receptacle, and configured to detachably attaching a smartcard to the receptacle. Optionally, each of the plurality of supports has a slot having a dimension matching with a dimension of a smartcard. Optionally, the kit includes at least a first support including a first slot having a first slot dimension and a second support including a second slot having a second slot dimension. Optionally, the first slot dimension is different from the second slot dimension. Optionally, the first slot dimension is the same as the second slot dimension. Optionally, the first support is configured to secure a first smartcard having a first smartcard dimension matching with the first slot dimension, and the second support is configured to secure a second smartcard having a second smartcard dimension matching with the second slot dimension. Optionally, the first smartcard dimension and the second smartcard dimension are different, and the first smartcard and the second smart card have a same pin configuration. Optionally, the first smartcard dimension and the second smartcard dimension are different, and the first smartcard and the second smart card have different pin configurations. Optionally, the accessory kit includes a plurality of receptacles configured for detachably attaching the plurality of supports, respectively. Optionally, the accessory kit includes a universal receptacle configured for detachably attaching the plurality of supports.

In some embodiments, the accessory kit includes a plurality of receptacles for detachably attaching a plurality of smartcards, respectively, to the apparatus main body; and a plurality of supports for detachably attaching a plurality of smartcards, respectively, to a receptacle. Optionally, each of the plurality of smartcards is configured to be detachably attached to the apparatus main body, e.g., through the receptacle detachably attached to a coupler. Optionally, each of the plurality of supports is configured to be detachably attached to a receptacle, and configured to detachably attaching a smartcard to the receptacle. Optionally, each of the plurality of supports has a slot having a dimension matching with a dimension of a smartcard. Optionally, the accessory kit further includes one or more coupler. Optionally, the coupler is affixed to the apparatus main body. Optionally, the coupler is detachably attached to the apparatus main body. Optionally, the coupler is a universal coupler for detachably attaching the plurality of receptacles to the apparatus main body. Optionally, the accessory kit includes a plurality of couplers configured to detachably attaching a plurality of receptacles to the apparatus main body, respectively. Optionally, each of the plurality of receptacles is configured to be detachably attached to the apparatus main body, e.g., through one of the plurality of couplers. Optionally, the accessory kit includes a plurality of receptacles configured for detachably attaching the plurality of supports, respectively. Optionally, the accessory kit includes a universal receptacle configured for detachably attaching the plurality of supports. Optionally, the accessory kit includes at least a first receptacle compatible with a first smartcard having a first pin configuration and a second receptacle compatible with a second smartcard having a second pin configuration. Optionally, the first pin configuration is different from the second pin configuration. Optionally, the first pin configuration is the same as the second pin configuration. Optionally, the accessory kit includes at least a first support including a first slot having a first slot dimension and a second support including a second slot having a second slot dimension. Optionally, the first slot dimension is different from the second slot dimension. Optionally, the first slot dimension is the same as the second slot dimension. Optionally, the first support is configured to secure a first smartcard having a first smartcard dimension matching with the first slot dimension, and the second support is configured to secure a second smartcard having a second smartcard dimension matching with the second slot dimension. Optionally, the first smartcard dimension and the second smartcard dimension are different, and the first smartcard and the second smart card have a same pin configuration. Optionally, the first smartcard dimension and the second smartcard dimension are different, and the first smartcard and the second smart card have different pin configurations.

Optionally, the accessory kit further includes instructions on how to attach a smartcard to the wearable apparatus. Optionally, the accessory kit further includes an opener for opening the casing to allow the smartcard to be attached to or detached from the apparatus main body. Optionally, the accessory kit further includes a firmware or a software. Optionally, the accessory kit further includes one or more smartcards. Optionally, the one or more smartcards are smartcards having security elements therein.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A wearable apparatus, comprising:
an apparatus main body comprising at least one receptacle for detachably attaching a smartcard;
wherein the wearable apparatus is compatible with a plurality of smartcards.

2. The wearable apparatus of claim 1, wherein the wearable apparatus is compatible with a plurality of smartcards having different pin configurations.

3. The wearable apparatus of claim 1, wherein the wearable apparatus is compatible with a plurality of smartcards having a same pin configuration but different dimensions.

4. The wearable apparatus of claim 1, wherein the apparatus main body further comprises a casing; and a motherboard enclosed by the casing; the at least one receptacle being disposed on the motherboard.

5. The wearable apparatus of claim 4, wherein the motherboard comprises a copper pour area comprising a plurality of electrical routing traces and a non-copper pour area outside the copper pour area;
the at least one receptacle are disposed on the motherboard in the non-copper pour area.

6. (canceled)

7. (canceled)

8. The wearable apparatus of claim 4, wherein the casing comprises an aperture through which the smartcard is configured to be attached to or detached from the at least one receptacle; and
the wearable apparatus further comprises a seal surrounding the aperture, the seal configured to form a waterproof closure of the aperture when the aperture is closed.

9. The wearable apparatus of claim 8, wherein the seal is a rubber seal.

10. The wearable apparatus of claim 4, wherein the casing comprises an aperture through which the smartcard is configured to be attached to or detached from the at least one receptacle; and
the wearable apparatus further comprises an aperture cover movably connected to the casing; and configured to be movable between a first position at which the aperture is accessible and a second position at which the aperture is substantially closed.

11. The wearable apparatus of claim 4, wherein the casing comprises an aperture through which the smartcard is configured to be attached to or detached from the at least one receptacle; and
the wearable apparatus further comprises an ejector configured to eject the smartcard.

12. (canceled)

13. (canceled)

14. The wearable apparatus of claim 1, wherein the apparatus main body comprises at least two receptacles each of which having a different pin configuration.

15. The wearable apparatus of claim 1, further comprising a smartcard detachably attached to the at least one receptacle;
wherein the smartcard comprises a security element integrated in the smartcard.

16. The wearable apparatus of claim 15, wherein the smartcard is one of a transit card chip, a dual interface card, a near field communication chip, a secure digital memory card, and a subscriber identity module card.

17. The wearable apparatus of claim 1, further comprising a support attached to the at least one receptacle and configured to detachably attaching the smartcard in the at least one receptacle;
wherein the support comprises a slot configured to receive the smartcard and have the smartcard latched therein.

18. The wearable apparatus of claim 1, wherein the at least one receptacle is detachably attached to the apparatus main body.

19. The wearable apparatus of claim 18, wherein the apparatus main body further comprises a casing and a motherboard enclosed by the casing;
the motherboard comprises a coupler for detachably attaching the at least one receptacle.

20. The wearable apparatus of claim 19, wherein the coupler comprises a guide rail for detachably attaching the at least one receptacle.

21. The wearable apparatus of claim 19, wherein the coupler comprises a bolt and a bolt hole cooperatively configured to secure the at least one receptacle to the coupler.

22. A kit, comprising:
a plurality of receptacles, each of which configured to be detachably attached to the apparatus main body;
wherein the plurality of receptacles comprise a first receptacle compatible with a first smartcard having a first pin configuration and a second receptacle compatible with a second smartcard having a second pin configuration, the first pin configuration being different from the second pin configuration.

23. (canceled)

24. A kit, comprising
a plurality of supports, each of which being configured to be detachably attached to the at least one receptacle, each of which being configured to detachably attaching a smartcard in the at least one receptacle;
wherein the plurality of supports comprise a first support comprising a first slot having a first slot dimension and a second support comprising a second slot having a second slot dimension, the first slot dimension being different from the second slot dimension.

25. The kit of claim 24, wherein the first support is configured to secure a first smartcard having a first smartcard dimension matching with the first slot dimension to the at least one receptacle; and the second support is configured to secure a second smartcard having a second smartcard dimension matching with the second slot dimension to the at least one receptacle; the first smartcard dimension and the second smartcard dimension being different.

26. (canceled)

27. (canceled)
